(19) United States
(12) Patent Application Publication
(10) Pub. No.: US 2025/0292126 A1
(43) Pub. Date: Sep. 18, 2025

(54) INFORMATION PROCESSING METHOD AND INFORMATION PROCESSING APPARATUS

(71) Applicant: Hitachi Vantara, Ltd., Yokohama-shi (JP)

(72) Inventor: Yusuke SUGITA, Tokyo (JP)

(73) Assignee: Hitachi Vantara, Ltd., Yokohama-shi (JP)

(21) Appl. No.: 18/827,966

(22) Filed: Sep. 9, 2024

(30) Foreign Application Priority Data
Mar. 13, 2024 (JP) 2024-039181

(51) Int. Cl. G06N 7/01

(52) U.S. Cl. CPC G06N 7/01

(57) ABSTRACT

According to a preferred aspect of the invention, provided is an information processing apparatus including a processor and a storage device. A penalty coefficient setting unit is implemented by the processor and the storage device using a solution finding function for obtaining a solution of a combinatorial optimization problem using a cost function and a constraint condition. The penalty coefficient setting unit sets a penalty function and a penalty coefficient based on the constraint condition related to a logical operation imposed between two variables of the cost function and a value of a model coefficient of the cost function such that the solution of the combinatorial optimization problem satisfies the constraint condition, and searches for the solution of the combinatorial optimization problem based on the penalty function and the penalty coefficient.

### BACKGROUND OF THE INVENTION

### 1. Field of the Invention

The present invention relates to an information processing method and an information processing apparatus.

### 2. Description of Related Art

PTL 1 discloses a method of executing a ground state search of an Ising model by adjusting a coefficient of a penalty function corresponding to a constraint condition while reducing a degree of violence for the constraint condition of a solution.

PTL 2 discloses a method of creating Ising models having different coefficients for penalty functions and performing a ground state search process in parallel with execution of information communication therebetween.

PTL 3 discloses that a coefficient adjustment of an extended Lagrange function is performed by using an algorithm referred to as an alternating multiplier method, and solution finding and the coefficient adjustment are repeatedly performed.

NPL 1 discloses forms of various information processing apparatuses (Ising machines) for obtaining an optimal solution (ground state) or a local optimal solution of a problem of minimizing an energy function of an Ising model.

NPL 2 discloses a method of returning a constrained optimization problem to a ground state search problem of an Ising model by creating a penalty function corresponding to a constraint condition.

### CITATION LIST

### Patent Literature

PTL 1: WO2022/024329

PTL 2: JP2019-159637A

PTL 3: JP2023-121046A

### Non Patent Literature

NPL 1: N. Mohseni, P. L. McMahon, and Tim Byrnes, Ising machines as hardware solvers of combinatorial optimization problems, Nat. Rev. Phys. 4, pp.363-379 (2022).

NPL 2: F. Glover, G. Kochenberger, and Y. Du, A Tutorial on Formulating and Using QUBO Models, in preprint (arXiv:1811.11538).

### SUMMARY OF THE INVENTION

Various physical phenomena and social phenomena can be expressed using a mathematical model. In particular, when a variable constituting this mathematical model is regarded as a node and is regarded as a network in which an energy function changes according to a state of the node, the mathematical model may be useful for understanding a phenomenon. The energy function is defined by a nonlinear coefficient (or referred to as an interaction coefficient) between nodes, a linear coefficient (or referred to as a bias coefficient or an external magnetic field coefficient) acting on each node, and the state of the node. A state of minimizing the energy function is referred to as a ground state.

Efficiently solving the ground state search problem of such a network is important for solving a social problem. For example, when a clique having a specific magnitude is to be detected for a social network, it is possible to solve a clique detection problem by configuring a model to decrease the energy function. The energy function used in this manner is also referred to as a cost function. In addition, by assigning a breakdown of a distribution of financial assets (referred to as a portfolio) as a variable to the node, it is possible to solve a problem of calculating a portfolio having a good evaluation index through the ground state search problem.

As a representative example of the model of the network as described above, there is an Ising model. The Ising model is a model in which each node takes two values of +1 and −1. A dedicated system for solving a ground state search of the Ising model by a physical phenomenon itself or an algorithm that is conceived on the physical phenomenon is referred to as an Ising machine. Here, a social problem to be solved is expressed as the model of the network, and a solution for the problem can be obtained by the Ising machine searching for the ground state.

When the problem is to be solved by the Ising machine, a constraint condition of the problem to be solved is often set as the penalty function and is added to the energy function to solve the problem. When a penalty coefficient which is a coefficient of the penalty function is too small, the solution does not satisfy the corresponding constraint condition, and when the penalty coefficient is too large, an influence of an original evaluation index on the solution becomes small. Therefore, it is necessary to appropriately set the penalty coefficient to adjust a specific gravity of the penalty function and the evaluation index.

The invention has been made in view of the above-described background, and an object thereof is to appropriately and efficiently set a magnitude of a penalty coefficient when a constraint condition related to a logical operation is expressed as a penalty function.

According to a preferred aspect of the invention, provided is an information processing apparatus including a processor and a storage device. A penalty coefficient setting unit is implemented by the processor and the storage device using a solution finding function for obtaining a solution of a combinatorial optimization problem using a cost function and a constraint condition. The penalty coefficient setting unit sets a penalty function and a penalty coefficient based on the constraint condition related to a logical operation imposed between two variables of the cost function and a value of a model coefficient of the cost function such that the solution of the combinatorial optimization problem satisfies the constraint condition, and searches for the solution of the combinatorial optimization problem based on the penalty function and the penalty coefficient.

According to another preferred aspect of the invention, provided is an information processing method using an information processing apparatus including a processor and a storage device, and an Ising machine that executes a ground state search of an Ising model. The information processing method includes: in obtaining a solution of a combinatorial optimization problem that satisfies a constraint condition by the Ising machine searching for a local optimal solution of a function reflecting an energy function and a penalty function, a first step of the information processing apparatus setting an interaction model using the energy function based on the combinatorial optimization problem; a second step of the information processing apparatus setting the penalty function based on the constraint condition, and calculating a weight of the penalty function for the solution to satisfy the constraint condition based on the energy function; and a third step of the Ising machine searching for the solution of the combinatorial optimization problem that satisfies the constraint condition by applying the penalty function and the weight of the penalty function to the energy function.

Other problems disclosed by the present application and methods for solving the problems will be made clear by the detailed description and drawings.

According to the invention, it is possible to appropriately and efficiently set a magnitude of a penalty coefficient when a constraint condition related to a logical operation is expressed as a penalty function. Problems, configurations, and effects other than those described above will become apparent in the following description of the embodiment of the invention.

### BRIEF DESCRIPTION OF THE DRAWINGS

FIG. 1 is a conceptual diagram of an energy landscape;

FIG. 2 is a conceptual diagram of simulated annealing, which is an algorithm for searching for an optimal solution;

FIG. 3 is a conceptual diagram showing that an energy landscape changes when a magnitude of a penalty coefficient, which is a weight of a penalty function for a cost function, is changed; a feasible solution and an infeasible solution mean a solution satisfying a constraint condition under consideration and a solution not satisfying the constraint condition under consideration, respectively;

FIG. 4 is a table in which representative logical operations for Boolean variables are expressed as linear expressions; although CIMPLY is not a general abbreviation, here, CIMPLY is defined as an abbreviation of converse imply;

FIG. 5 is a conceptual diagram showing that a certain variable and a variable whose domain of definition is switched by a value of the certain variable are converted into two variables whose domain of definition falls within a section [0, 1];

FIG. 6 is a conceptual diagram showing a variable conversion in which two variables in the section [0, 1] are converted into two variables in a section [−1, 1];

FIG. 7 is a diagram showing an executable region of a constraint condition related to four logical operations;

FIG. 8 is a contour graph showing an energy landscape when two variables on which a NAND constraint is imposed are changed in a case in which the penalty function is absent and a case in which the penalty function is present; it is indicated that the darker (whiter) the position in state, the smaller (larger) the value of the energy function; x* indicates a local optimal solution when xᵢ and xⱼ are moved;

FIG. 9 is a block diagram of a calculation circuit;

FIG. 10 is a functional block diagram showing main functions of an information processing apparatus;

FIG. 11 is a flowchart of an overall ground state search process;

FIG. 12 is a flowchart of a method of setting a penalty coefficient for satisfying a logical constraint between two variables; and

FIG. 13 is a conceptual diagram of a user interface showing a progress of the ground state search process.

### DETAILED DESCRIPTION

An embodiment will be described in detail with reference to the drawings. However, the invention is not to be construed as being limited to the description of the embodiment described below. It will be easily understood by those skilled in the art that the specific configuration can be changed without departing from the spirit or scope of the invention.

The notations “first”, “second”, “third”, and the like in the present description are provided to identify components and do not necessarily limit the number, the order, or the content thereof. A number for identifying a component is used for each context, and a number used in one context does not necessarily indicate the same configuration in another context. In addition, this does not prevent a component identified by a certain number from also having a function of a component identified by another number.

In order to facilitate understanding of the invention, the position, magnitude, shape, range, and the like of each configuration shown in the drawings or the like may not represent the actual position, magnitude, shape, range, and the like. Therefore, the invention is not necessarily limited to the positions, magnitudes, shapes, ranges, and the like disclosed in the drawings or the like.

Publications, patents, and patent applications cited in the present description constitute a part of the description of the present description.

In the present description, a component represented by a single form includes a plural form unless it is clearly described in the context.

A configuration of the embodiment may be implemented by a single computer, or any part of an input device, an output device, a processing device, and a storage device may be implemented by another computer connected via a network. This is equivalent to a concept of the invention, and there is no change.

In the present embodiment, a function equivalent to a function implemented by software can also be implemented by hardware such as a field programmable gate array (FPGA) or an application specific integrated circuit (ASIC). Such an embodiment is also included in the scope of the invention.

In the following embodiment, an example or the like is described in which an appropriate coefficient value of a penalty function is determined for a logical constraint between two variables for a mixed-binary quadratic programming problem, thereby efficiently searching for a good solution satisfying the constraint condition.

In the following description, the same or similar components are denoted by the same reference numerals, and a redundant description thereof may be omitted. When there are a plurality of components having the same or similar functions, the same reference numerals may be assigned with different subscripts. In addition, when it is not necessary to distinguish the plurality of elements from each other, the subscripts may be omitted.

First, an energy function of a model of a network will be described. An energy function H(x) (also referred to as Hamiltonian) is defined by a plurality of nodes constituting a model, a nonlinear coefficient acting between the nodes, and a linear coefficient acting on each node. Here, x is a vector having a variable xᵢ corresponding to each node i (i=1 to N, N is a natural number) as an element, and each variable xᵢ is a binary variable xᵢ∈{−1, 1} or a continuous variable xᵢ∈[−1, 1]. Further, when a nonlinear coefficient between the node i and a node j is Jᵢⱼ and a linear coefficient for the node i is hᵢ, the energy function is the following quadratic expression.

$$H ( x ) := - \frac{1}{2} {x}^{T} Jx - {h}^{T} x \qquad ( Formula 1 )$$

In Formula 1, the first term can be regarded as expressing an interaction between nodes, and the second term can be regarded as expressing energy by bias to the node. Here, the network can be expressed as an undirected graph, and Jᵢⱼ=Jⱼᵢ, that is, a matrix J in Formula 1 is a real symmetric matrix.

The energy function of Formula 1 is a concept including an Ising model. When all variables are limited to the binary variable xᵢ∈{−1, 1}, the model of the network is an Ising model. The Ising model is used as, for example, a lattice model in which a magnetic material is described by statistical mechanics, and +1 and −1 correspond to up and down directions of a spin.

A ground state search of Formula 1 is an optimization problem of obtaining a state x at which the energy function is minimized. This is equivalent to a mixed-binary quadratic programming problem with a section constraint on variables.

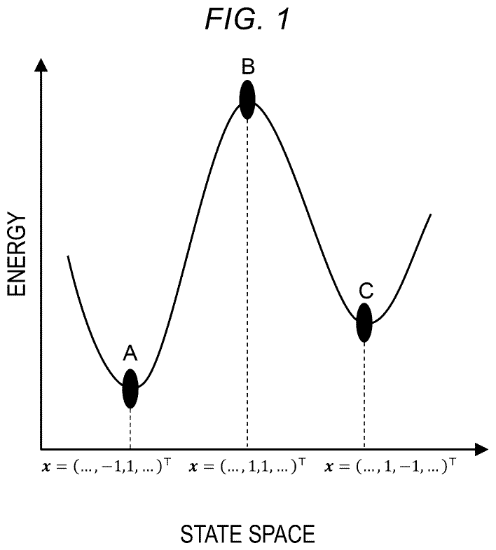

FIG. 1 is a conceptual diagram of an energy landscape of Formula 1. In the graph, a horizontal axis represents a state space which is a domain of definition of the state x, and a vertical axis represents a value of the energy function. In FIG. 1, energy of a state A is the smallest, when −1 is updated to 1 from the state A, a state B with larger energy is obtained, and when 1 is updated to −1, a state C with smaller energy is obtained.

An Ising machine is a computer specialized for obtaining an optimal solution or a local optimal solution of Formula 1 or a ground state search problem of the Ising model at a high speed. Details are described in NPL 1, and an outline thereof will be described here. As an operation principle for obtaining a ground state, there are simulated annealing, which is an algorithm simulating a fluctuation of a thermal state of a physical system, quantum annealing utilizing a fluctuation of a state due to a quantum effect, and an operation principle utilizing behavior of a dynamical system. In addition, as a method of implementing the operation principle, there is a method of directly utilizing a physical phenomenon in a simulator using an electronic circuit, an optical circuit, a superconducting quantum circuit, or the like.

Here, the simulated annealing will be described as an example of the operation principle of the Ising machine. T referred to as an annealing parameter or a temperature parameter is introduced as a parameter corresponding to a temperature of the physical system. For the vector x having the energy function E(x), a probability density function referred to as a Boltzmann distribution is as follows.

$$p ( x ) := \frac{1}{Z} exp ( - \frac{E ( x )}{T} ) \qquad ( Formula 2 )$$

Z is a normalization factor of the Boltzmann distribution referred to as a partition function. For example, when the Boltzmann distribution for the energy function of Formula 1 is to be considered, it is sufficient that E(x)=H(x).

There is a Markov chain Monte Carlo method as a method of updating a state such that the state x appears probabilistically according to the Boltzmann distribution of Formula 2. One of methods of satisfying a requirement of the Markov chain Monte Carlo method is Gibbs sampling (or a heat bath method). The state generated in the i-th step by the Gibbs sampling is x⁽ⁱ⁾={x₁⁽ⁱ⁾, . . . , x_{N}⁽ⁱ⁾}. At this time, it is known that the state {x} appears with a probability according to Formula 2 by sequentially updating the state at the (i+1)-th time with n=1, . . . , N according to a conditional probability.

$${x}_{n}^{( i + 1 )} ∼ p ( {x}_{n} \vert {x}_{1}^{( i + 1 )} , … , {x}_{n - 1}^{( i + 1 )} , {x}_{n + 1}^{( i )} , … , {x}_{N}^{( i )} ) \qquad ( Formula 3 )$$

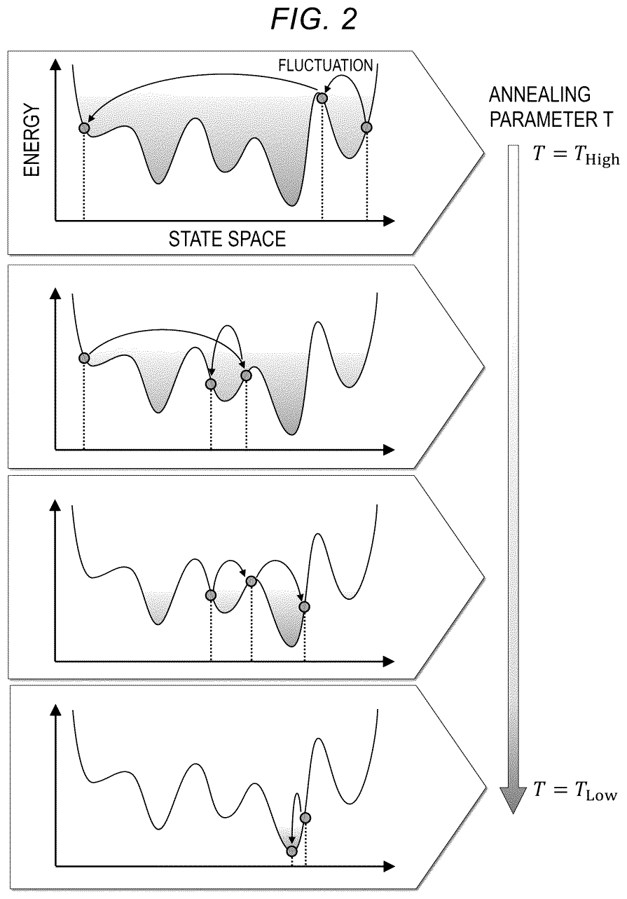

Here, as shown in FIG. 2, it is considered that the temperature parameter T is gradually reduced from a maximum value T_{High} to a minimum value T_{Low} while the state is updated, such that the state probabilistically appears according to the Boltzmann distribution of Formula 2. Accordingly, an appearance probability of the state in which the energy function E(x) is small gradually increases, and the state can gradually converge to the ground state. The operation principle of the simulated annealing is described above.

As in the simulated annealing described above, the Ising machine targets a ground state search problem of a certain energy function E(x). Therefore, when the ground state search is performed in consideration of the constraint condition related to the state x, ingenuity is required.

There is a penalty function method as a method of handling a constraint condition. As described in NPL 2, in the penalty function method, a penalty function P(x) that takes 0 when the state x satisfies a target constraint condition and takes a positive value when the state x does not satisfy the target constraint condition is constructed (a specific example will be described later). In the penalty function method, a new energy function which is a sum of the energy function H(x) corresponding to an original evaluation index and a weighted penalty function P(x) is considered.

$$E ( x ) = H ( x ) + α P ( x ) \qquad ( Formula 4 )$$

This α is referred to as a penalty coefficient.

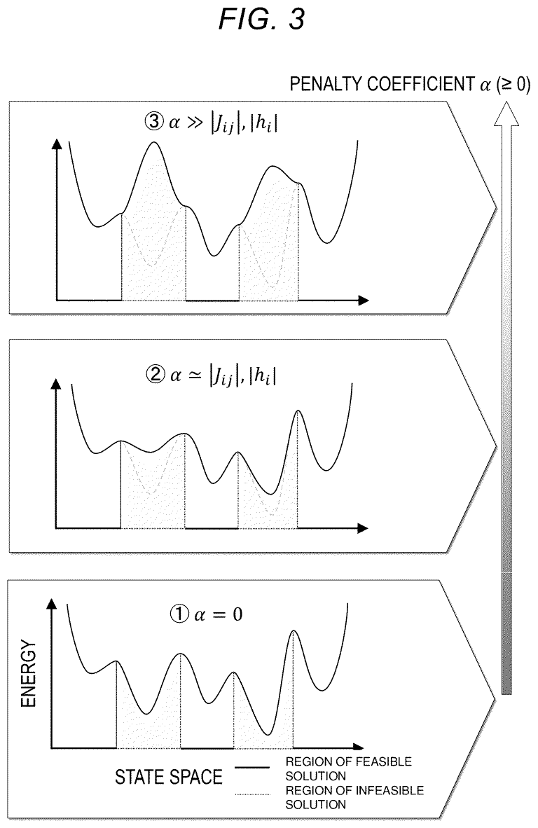

FIG. 3 shows a change in energy landscape of Formula 4 when a magnitude of α is changed. When α=0, the penalty function is ignored, and thus a ground state of the energy function E(x)=H(x) of Formula 4 may become an infeasible solution instead of a solution satisfying the constraint condition (referred to as a feasible solution). When the magnitude of α increases, a value of an energy function of the infeasible solution increases, and thus the ground state is less likely to appear in a region of the infeasible solution. When a sufficiently large positive value is taken as α, the ground state of the energy function E(x) of Formula 4 is the feasible solution.

PTL 1 discloses a method of executing a ground state search of an Ising model by adjusting a coefficient of a penalty function corresponding to a constraint condition while reducing a degree of violence for the constraint condition of a solution. In addition, PTL 2 discloses a method of creating Ising models having different coefficients for penalty functions and performing a ground state search process in parallel with execution of information communication therebetween. Thus, it is possible to set an appropriate penalty coefficient by adjusting the penalty coefficient repeatedly and gradually.

However, as described above, since the appropriate magnitude of the penalty coefficient is different for each problem, even when the appropriate magnitude of the penalty coefficient is to be searched for, when the initial value deviates greatly from the appropriate value, the search may not be performed efficiently.

Therefore, in the present embodiment, attention is paid to a constraint condition of a logical operation related to truth or falsity of a proposition frequently appearing in the formulations of practical combinatorial optimization problems. Hereinafter, this is referred to as a logical constraint. As the detail will be described later, a required upper bound of the penalty coefficient α for the logical constraint can be calculated based on the value of the energy function H(x). That is, the initial value of the search for the penalty coefficient can be estimated accordingly.

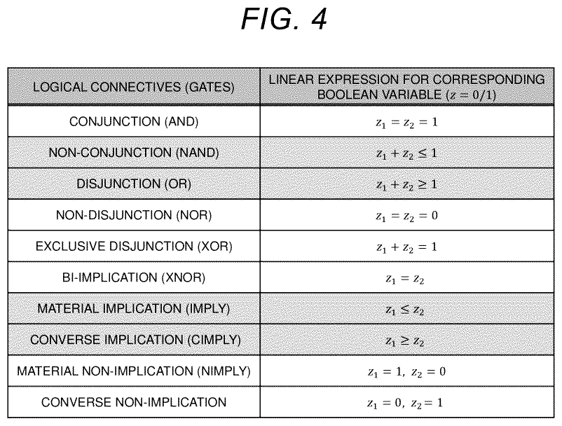

FIG. 4 is a table in which representative logical operations for Boolean variables are represented as linear expressions. When Boolean variables zᵢ representing the truth or falsity of the proposition take values of 1 and 0 respectively corresponding to true and false, the logical constraint between two basic variables can be represented as shown in FIG. 4. For example, FIG. 4 summarizes that in order to obtain z₁ AND z₂=1, that is, true, it is required that z₁=z₂=1.

In FIG. 4, a conjunction (AND), a non-disjunction (NOR), and a material non-implication (NIMPLY), and a converse non-implication allow the values of two variables on which the constraint condition is imposed to be determined in order to make the corresponding logical constraint true, and thus the constraint condition can be deleted from the problem by fixing the variables. An exclusive disjunction (XOR) and a bi-implication (XNOR) become an equality constraint between two variables, and thus the constraint condition can be deleted from the problem by expressing one variable by the other variable. Therefore, hereinafter, a non-conjunction (NAND), a disjunction (OR), a material implication (IMPLY), and a converse implication (CIMPLY) in which a degree of freedom remains in the feasible solution state will be focused on. Although CIMPLY is not a general abbreviation, CIMPLY is used herein as an abbreviation of the converse implication.

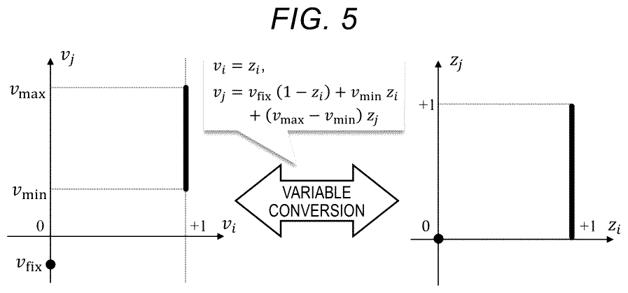

An example in which a logical constraint appears is shown. FIG. 5 is a conceptual diagram showing that a certain variable and a variable whose domain of definition is switched by a value of the certain variable are converted into two variables whose domain of definition falls within a section [0, 1].

As shown in FIG. 5, when a variable vi serving as a certain flag is on (vᵢ=1), a variable vⱼ should take a value vₘᵢₙ≤vⱼ≤vₘₐₓ in a certain range, and when the variable vᵢ is off (vᵢ=0), the variable vⱼ should take a value, vⱼ=v_{fix}. Such a constraint condition frequently appears in the mathematical optimization modeling. An example that appears in financial portfolio optimization is the constraint that selected stocks are allowed to change their investment ratio, while stocks not selected remain at their current ratio.

The constraint between the two variables is represented by the following formula.

$${v}_{j} = {v}_{fix} if {v}_{i} = 0 , {v}_{min} \leq {v}_{j} \leq {v}_{max} if {v}_{i} = 1 \qquad ( Formula 5 )$$

Here, Formula 5 can be rewritten into the following constraint condition by a variable conversion.

$${v}_{i} = {z}_{i} , {v}_{j} = {v}_{fix} ( 1 - {z}_{i} ) + {v}_{min} {z}_{i} + ( {v}_{max} - {v}_{min} ) {z}_{j} \qquad ( Formula 6 )$$

$${z}_{i} \geq {z}_{j} ( {z}_{i} ∈ \{ 0 , 1 \} , {z}_{j} ∈ [ 0 , 1 ] ) \qquad ( Formula 7 )$$

This is CIMPLY in FIG. 4 corresponding to a binary variable zᵢ∈{0, 1} and a continuous variable zⱼ∈[0, 1]. In many cases, the constraint condition represented by the actual problem as described above can be expressed as a logical constraint as shown in FIG. 4 by performing the variable conversion as necessary.

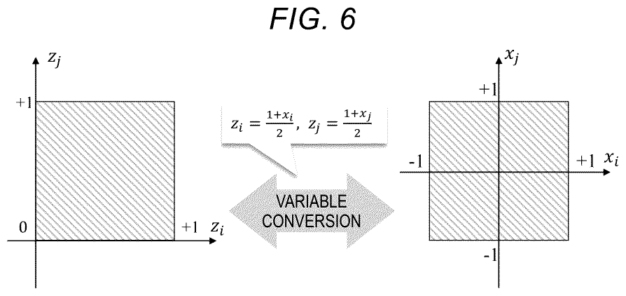

In the following, in order to handle the logical constraint in the Ising machine, the variables in the section [0, 1] in FIG. 4 are handled in a format converted into variables in the section [−1, 1]. Therefore, here, the following variable conversion shown in FIG. 6 is performed.

$${z}_{i} = \frac{1 + {x}_{i}}{2} , {z}_{j} = \frac{1 + {x}_{j}}{2} \qquad ( Formula 8 )$$

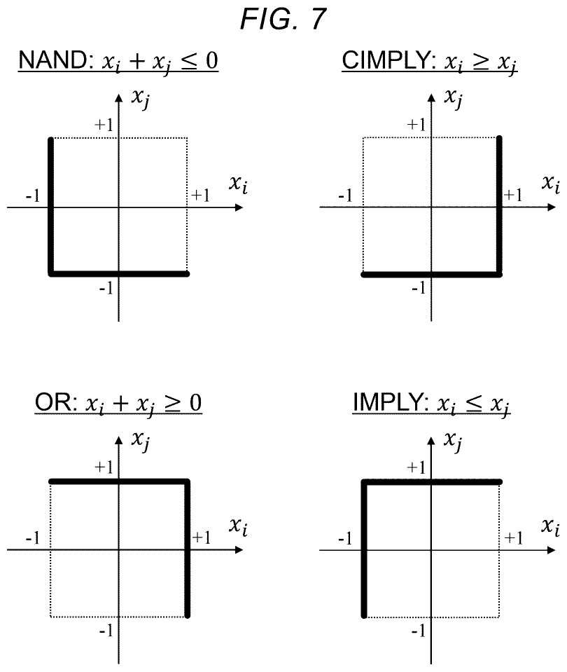

FIG. 6 is a conceptual diagram showing a variable conversion in which two variables in the section [0, 1] are converted into two variables in the section [−1, 1]. When the variable conversion is performed, regions indicated by thick lines in FIG. 7 are the feasible solutions for NAND, OR, IMPLY, and CIMPLY.

The following penalty function is considered such that the regions indicated by the thick lines in FIG. 7 are feasible solutions, and other regions of xᵢ, xⱼ∈[0, 1] are infeasible solutions.

$$P ( x ) = \{ \begin{matrix}( 1 + {x}_{i} ) ( 1 + {x}_{j} ) & for {x}_{i} NAND {x}_{j} \\ ( 1 - {x}_{i} ) ( 1 + {x}_{j} ) & for {x}_{i} CIMPLY {x}_{j} \\ ( 1 - {x}_{i} ) ( 1 - {x}_{j} ) & for {x}_{i} OR {x}_{j} \\ ( 1 + {x}_{i} ) ( 1 - {x}_{j} ) & for {x}_{i} IMPLY {x}_{j}\end{matrix} \qquad ( Formula 9 )$$

Values are clearly 0 in the regions indicated by the thick lines in FIG. 7, and are positive values in other regions.

Hereinafter, it will be described that an upper bound of the penalty coefficient α required for a local minimum solution x* of Formula 4 to present in the region of the feasible solution of FIG. 7 is obtained for Formulas 1 and 9. In particular, a case of xᵢ NAND xⱼ will be described, but the same discussion can be applied to cases of CIMPLY, OR, and IMPLY. Further, xᵢ is the binary variable xᵢ∈{−1, 1}, and xⱼ is a binary variable xⱼ∈{−1, 1} or a continuous variable xⱼ∈[−1, 1].

Regarding xᵢ NAND xⱼ, when xᵢ=−1, the domain of definition of xⱼ is entirely the feasible solution, and thus the case of xᵢ=1 is considered. When a portion depending on xⱼ is written in Formula 4 based on Formula 1 and Formula 9, the following is obtained.

$$E ( x ) ∝ - \frac{1}{2} {J}_{jj} {x}_{j}^{2} + ( 2 α - {J}_{ij} - {\sum }_{k \neq i , j} {J}_{kj} {x}_{k} - {h}_{j} ) {x}_{j} \qquad ( Formula 10 )$$

Therefore, a sufficient condition x*ⱼ=−1 is considered if x*ⱼ=1. First, when Jⱼⱼ=0, based on Formula 10, if the following is obtained,

$$2 α - {J}_{ij} - {\sum }_{k \neq i , j} {J}_{kj} {x}_{k}^{*} - {h}_{j} > 0 \qquad ( Formula 11 )$$

x*ⱼ=−1. A sufficient condition for this is the following.

$$α > ( {\sum }_{j} \vert {J}_{ij} \vert + \vert {h}_{j} \vert ) / 2 \qquad ( Formula 12 )$$

Next, when Jⱼⱼ<0, when a portion depending on the value of xⱼ is written based on Formula 10, the following is obtained.

$$E ( {x}^{*} ) ∝ - \frac{1}{2} {{J}_{jj} ( {x}_{k}^{*} - \frac{2 α - {J}_{ij} - {\sum }_{k \neq i , j} {J}_{kj} {x}_{k}^{*} - {h}_{j}}{{J}_{jj}} )}^{2} \qquad ( Formula 13 )$$

Then, if the following is obtained,

$$( 2 α - {J}_{ij} - {\sum }_{k \neq i , j} {J}_{kj} {x}_{k}^{*} - {h}_{j} ) / {J}_{jj} < - 1 \qquad ( Formula 14 )$$

x*ⱼ=−1. Therefore, the sufficient condition for this is Formula 12. Finally, when Jⱼⱼ>0, based on Formula 13, if the following is obtained,

$$( 2 α - {J}_{ij} - {\sum }_{k \neq i , j} {J}_{kj} {x}_{k}^{*} - {h}_{j} ) / {J}_{jj} > 0 \qquad ( Formula 15 )$$

x*ⱼ=−1. The sufficient condition is Formula 12. From the above discussion, when a larger than the right side of Formula 12 is used, the local minimum solution x* of Formula 4 is the feasible solution of xᵢ NAND xⱼ.

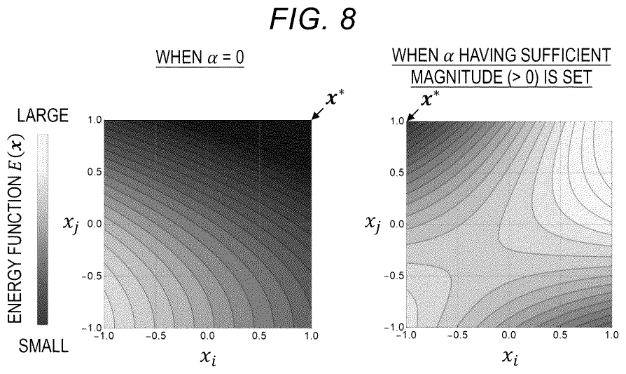

FIG. 8 schematically shows the above discussion. When α=0, that is, when an influence of the penalty function does not act on Formula 4, x*ᵢ, x*ⱼ of the local optimal solution x* may not be the feasible solution of xᵢ NAND xⱼ. However, if α is set within a range satisfying Formula 14, as shown in FIG. 8, the value of the energy function E(x) other than the feasible solution of xᵢ NAND xⱼ becomes large, and the local minimum solution x* is present in a region satisfying xᵢ NAND xⱼ₋. In the range satisfying xᵢ NAND xⱼ, E(x)=H(x)+αP(x)=H(x) also holds.

In addition, it is shown that the magnitude of the penalty coefficient sufficient for the local optimal solution to satisfy the NAND constraint is obtained from a model coefficient of the original energy function H(x) for one NAND constraint. As shown in Formula 9, the penalty functions for CIMPLY, OR, and IMPLY differ only in sign from the penalty function for NAND, so the same argument for the penalty coefficient can be made as above. In addition, a case is considered in which a plurality (k=1, . . . , K) of penalty functions and penalty coefficients are present for logical constraints as shown in the following Formula.

$$E ( x ) = H ( x ) + {\sum }_{k = 1}^{K} {α}_{k} {P}_{k} ( x ) = : - \frac{1}{2} {x}^{⊤} {J}^{′} x - {h}^{′ ⊤} x + const . \qquad ( Formula 16 )$$

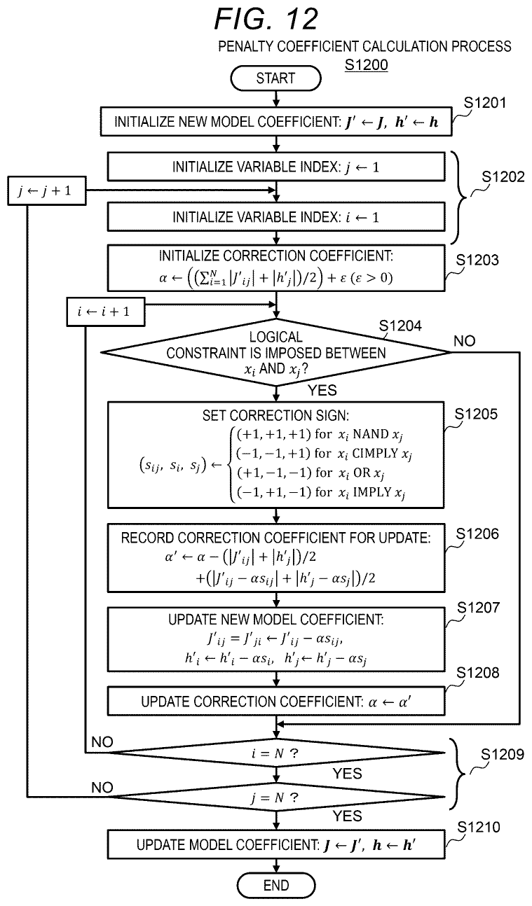

In this case, the upper bounds required for the penalty coefficients α₁, . . . , αₖ can be calculated sequentially by applying the above discussion repeatedly. A flowchart in which the above contents are summarized will be described later (FIG. 12).

Next, an embodiment of an information processing apparatus that performs the above-described information processes will be described.

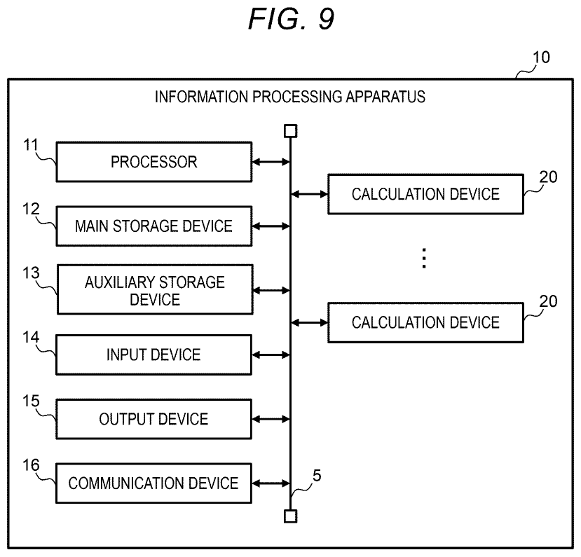

An information processing apparatus 10 shown in FIG. 9 includes a processor 11, a main storage device 12, an auxiliary storage device 13, an input device 14, an output device 15, a communication device 16, one or more calculation devices 20, and a system bus 5 that communicably connects these devices. The information processing apparatus 10 may be partially or entirely implemented using a virtual information processing resource such as a cloud server provided by a cloud system. In addition, the information processing apparatus 10 may be implemented by, for example, a plurality of information processing apparatuses that operate in cooperation with one another and that are communicably connected to one another.

The processor 11 is implemented by using, for example, a central processing unit (CPU) or a micro processing unit (MPU). The main storage device 12 is a device that stores programs and data, and is a read only memory (ROM) (a static random access memory (SRAM), a non volatile RAM (NVRAM), a mask read only memory (mask ROM), a programmable ROM (PROM), or the like), a random access memory (RAM) (a dynamic random access memory (DRAM), or the like), or the like. The auxiliary storage device 13 is a hard disk drive, a flash memory, a solid state drive (SSD), an optical storage device (a compact disc (CD), a digital visual disc (DVD), or the like), or the like. The programs and data stored in the auxiliary storage device 13 are read into the main storage device 12 as needed.

The input device 14 is a user interface for receiving an input of information from a user, and is, for example, a keyboard, a mouse, a card reader, or a touch panel. The output device 15 is a user interface for outputting information to a user, and is, for example, a display device (a liquid crystal display (LCD), a graphic card, or the like) that visualizes various types of information, an audio output device (speaker), or a printing device. The communication device 16 is a communication interface for communicating with other devices, and is, for example, a network interface card (NIC), a wireless communication module, a universal serial interface (USB) module, or a serial communication module.

The calculation device 20 is a device that executes a ground state search known as the Ising machine, for example. The calculation device 20 may take a form of an expansion card attached to the information processing apparatus 10, such as a graphics processing unit (GPU). The calculation device 20 is implemented by hardware such as a complementary metal oxide semiconductor (CMOS) circuit, a field programmable gate array (FPGA), or an application specific integrated circuit (ASIC).

The calculation device 20 includes a control device, a storage device, an interface for connecting to the system bus 5, and the like, and transmits and receives commands and information to and from the processor 11 via the system bus 5. For example, the calculation device 20 may be communicably connected to another calculation device 20 via a communication line and operate in cooperation with another calculation device 20. Functions implemented by the calculation device 20 may be implemented by, for example, causing the processor (CPU, GPU, and the like) to execute a program.

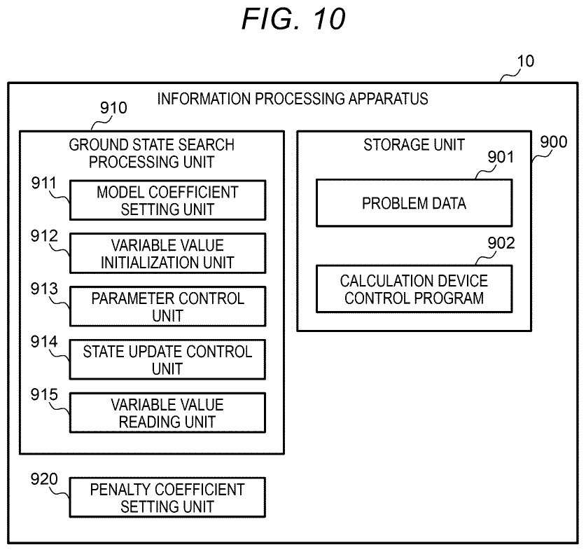

FIG. 10 shows main functions of the information processing apparatus 10. The information processing apparatus 10 is an apparatus for solving a mixed-binary quadratic programming problem, reads a constraint condition related to a logical operation imposed between variables of the problem, and operates based on a method of setting an appropriate penalty function and penalty coefficient for each logical constraint from a value of an energy function, thereby effectively solving the mixed-binary quadratic programming problem having the above-described constraint condition. With such a configuration, an appropriate coefficient value of a penalty function for a logical constraint between two variables is determined for a mixed-binary quadratic programming problem, thereby efficiently searching for a good solution satisfying the constraint condition.

As shown in FIG. 10, the information processing apparatus 10 includes a storage unit 900, a ground state search processing unit 910, and a penalty coefficient setting unit 920. These functions are implemented by the processor 11 reading and executing a program stored in the main storage device 12 or by hardware included in the calculation device 20. In addition to the above functions, the information processing apparatus 10 may have other functions such as an operating system, a file system, a device driver, and a database management system (DBMS).

The storage unit 900 in the above functions stores problem data 901 and a calculation device control program 902 in the main storage device 12 or the auxiliary storage device 13. The problem data 901 is data in which a combinatorial optimization problem is input in a predetermined description format, and holds information of nonlinear coefficients, linear coefficients, types of variables, and constraint conditions in Formula 1. The problem data 901 is set by a user via, for example, a user interface (input device, output device, communication device, or the like). The calculation device control program 902 is a program for controlling an operation order and communication of the ground state search processing unit 910 and the penalty coefficient setting unit 920.

The ground state search processing unit 910 in the above functions includes a model coefficient setting unit 911, a variable value initialization unit 912, a parameter control unit 913, a state update control unit 914, and a variable value reading unit 915.

The model coefficient setting unit 911 passes information on a model to the calculation device 20 based on the problem data 901.

The variable value initialization unit 912 initializes a value stored in a variable memory of the calculation device 20.

The parameter control unit 913 controls a parameter of the ground state search process. For example, the parameter control unit 913 controls a temperature parameter in the simulated annealing.

The state update control unit 914 executes a state update and a calculation related to the state update in the ground state search process, and is a part of the calculation device 20. For example, the state update control unit 914 executes a Gibbs sampling process in the simulated annealing.

The variable value reading unit 915 reads, when the calculation device 20 completes the ground state search process, the value stored in the variable memory and outputs the read value to the output device 15 or the communication device 16, thereby ending the ground state search process.

The penalty coefficient setting unit 920 reads a model coefficient and a logical constraint from the problem data 901, and calculates the penalty coefficient and corrects the model coefficient. The processor 11 and the calculation device 20 can be utilized for such processes.

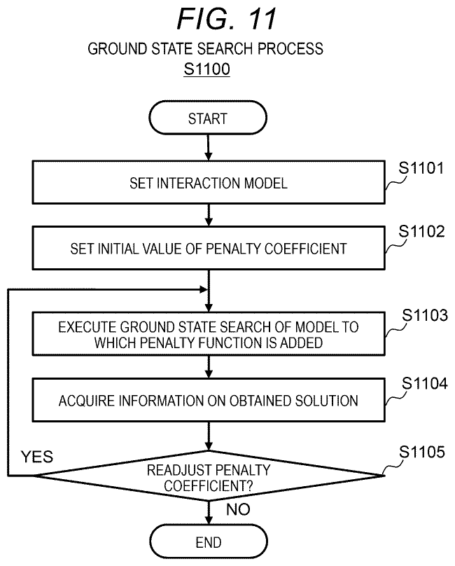

FIG. 11 is a flowchart showing the entire process performed by the information processing apparatus 10 for the ground state search for solving the combinatorial optimization problem (hereinafter, referred to as a ground state search process S1100). Hereinafter, the ground state search process S1100 will be described with reference to FIG. 11. In the following description, a letter “S” attached before a reference sign means a step of the process. The ground state search process S1100 is started by, for example, receiving an instruction or the like from the user via the input device 14.

First, the model coefficient setting unit 911 sets information on model coefficients J and h in the calculation device 20 based on a target combinatorial optimization problem (S1101). Values thereof can also be set or edited by a user via a user interface (implemented by the input device 14, the output device 15, the communication device 16, or the like).

Subsequently, based on the logical constraint input by the user, an initial value of the penalty coefficient of the logical constraint is determined from the method described in the embodiment (S1102). Details of this process S1102 will be described later together with the description of a flowchart of FIG. 12. The initial value of the penalty coefficient in the process S1102 is a correction coefficient a obtained as a result of the process of FIG. 12.

Subsequently, the variable value initialization unit 912 initializes the variable value of the calculation device 20, and then the parameter control unit 913 and the state update control unit 914 give an instruction to the calculation device 20 to execute the ground state search (S1103). As for the ground state search using the Ising machine or the like, there are known techniques that can be applied, and therefore the description thereof is omitted here.

Subsequently, the variable value reading unit 916 reads the value stored in the variable memory of the calculation device 20 and stores the value as a result of the ground state search (S1104). Here, how much the obtained solution satisfies the given logical constraint, and what kind of performance is indicated with respect to an evaluation index of the problem are evaluated.

Subsequently, if there is a request based on an evaluation result in S1104, a new penalty coefficient is calculated again (S1015: YES). If there is no request, the solutions obtained so far are stored as the result of the ground state search, and the ground state search process S1100 ends. Readjustment of the penalty coefficient performed as necessary in the process S1015 can be performed by a known method as shown in, for example, PTL 1 and PTL 2.

In the above embodiment, since the upper bound is given as the initial value of the penalty coefficient in the process S1102, a solution satisfying the constraint condition can be obtained if the process S1103 acquires a true optimal solution. However, in the process of the process S1103 performed by the Ising machine, in consideration of the case in which only the local optimal solution is obtained (the constraint condition is not sufficiently satisfied), a flow is made in consideration of a possibility of tuning from the initial value.

FIG. 12 is a flowchart showing a process performed by the information processing apparatus 10 in order to calculate the penalty coefficient corresponding to the logical constraint input by the user (hereinafter, referred to as a penalty coefficient calculation process S1200 (S1102)) The contents and operations of main processes will be described below. S1200 is started when an instruction or the like is received in S1102 of FIG. 11.

First, in order to calculate penalty coefficients based on the original model coefficients J and h, the model coefficients are copied to another memory (S1201). The copied model coefficients are written as new model coefficients J′ and h′. The model coefficient setting unit 911 sets information on the model coefficient in the calculation device 20. The new model coefficient is temporarily written to, for example, the auxiliary storage device 13.

Thereafter, the logical constraint imposed between the variables xᵢ and xⱼ is sequentially checked. Therefore, i and j are initialized to sequentially check i and j=1, . . . , N (S1202). In this flow, it is sequentially checked whether the logical constraint is imposed on xᵢ=x₁, . . . , x_{N} related to xⱼ.

Subsequently, a value to be a candidate of the penalty coefficient and a correction coefficient are calculated based on the new model coefficients J′ and h′ (S1203). This corresponds to the value of α in Formula 12. As ε, an appropriate positive value is sufficiently adopted (for example, a minimum value of accuracy when numerical calculation is performed with single accuracy or double accuracy).

Subsequently, it is checked whether any logical constraint of NAND, CIMPLY, OR, and IMPLY is imposed between xᵢ and xⱼ. When no logical constraint is imposed (S1204: NO), there is no operation related to i and j. When the logical constraint is imposed (S1204: YES), the process proceeds to an operation of correcting the penalty coefficient to the new model coefficient related to i and j.

Subsequently, correction signs (sᵢⱼ, sᵢ, and sⱼ) for reflecting differences in sign of the penalty function for each of NAND, CIMPLY, OR, and IMPLY are set (S1205).

Subsequently, in order to calculate the penalty coefficient after i+1, a value of a correction coefficient α′ is recorded (S1206).

Subsequently, a correction corresponding to the penalty coefficient is added to the new model coefficients J′ and h′ (S1207). The value of α is a penalty coefficient between xᵢ and xⱼ.

Subsequently, the correction coefficient α to be used in the subsequent calculation of the correction coefficient is updated with the temporarily recorded correction coefficient α′ (S1208).

Subsequently, in relation to the indices i and j of the variables, it is confirmed whether the check between all xᵢ and xⱼ is completed, and if not completed, the process returns to the above operation (S1209).

Finally, the model coefficients are updated with the new model coefficients reflecting the penalty coefficients of all the logical constraints (S1210), and the penalty coefficient calculation process S1200 ends.

In the process S1206, the correction coefficient α′ for update is the following.

$${α}^{′} = ( {\sum }_{k \neq i} \vert {J}_{kj}^{′} \vert + \vert {J}_{ij}^{′} - α {s}_{ij} \vert + \vert {h}_{j}^{′} - α {s}_{j} \vert ) / 2 + ε \qquad ( Formula 17 )$$

This corresponds to the right side of Formula 12 corresponding to the new model coefficient updated in the process S1207. The term added to or subtracted from α in the process S1206 corresponds to the correction (added or subtracted value) for J′ and h′ in the process S1207. α′ corresponds to the right side of Formula 12 with respect to the model coefficient updated in S1207, and is the upper bound of the penalty coefficient calculated using the updated model coefficient. In S1208, α is updated to this value, and thereafter, the update of the model coefficient is sequentially considered.

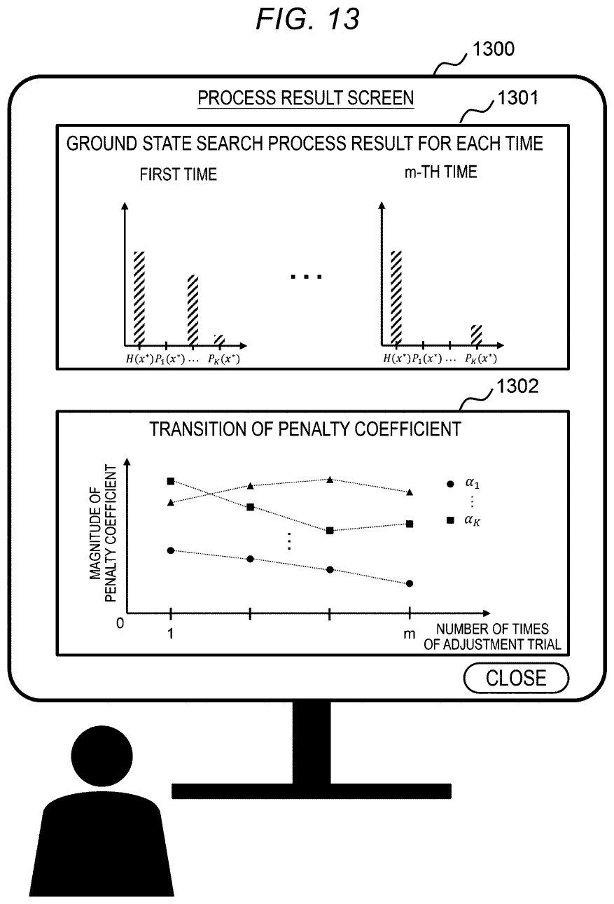

FIG. 13 shows an example of a user interface that displays the state in accordance with the progress of the ground state search process S1100. With such a user interface, the user can check a setting of the penalty coefficient and an evaluation status of the performance thereof described in the above embodiment.

A process result screen 1300 includes a ground state search process result display region 1301 for each time and a display region 1302 for the value of the penalty coefficient for each time. Here, each time corresponds to the loop of S1103 to S1105 in FIG. 11.

In the ground state search process result display region 1301 for each time, the results of evaluating the values of the energy function and the penalty function are displayed for the obtained solutions. When the penalty coefficient is not zero, adjustment is performed in the next loop, for example, a larger penalty coefficient is imposed.

In the display region 1302 of the value of the penalty coefficient, the value of the penalty coefficient in each loop is displayed, and the user can check how the value is gradually adjusted. Accordingly, the user can read whether the initial value is too large, a relationship between the magnitudes of the parameters, and the like.

Although the embodiment is described in detail, the invention is not limited to the embodiment, and it is needless to say that various modifications can be made without departing from the gist of the invention. For example, the embodiment described above is described in detail to facilitate understanding of the invention, and the invention is not necessarily limited to those including all the configurations described above. In addition, another configuration can be added to, deleted from, or replaced with a part of a configuration of each embodiment.

In addition, a part or all of the configurations, function units, processing units, processing methods, and the like described above may be implemented by hardware by, for example, integrated circuit. In addition, the designing with an configurations, functions, and the like described above may be implemented by software by a processor interpreting and executing a program for implementing each function. Information such as a program, a table, and a file for implementing each function can be stored in a recording device such as a memory, a hard disk, and a solid state drive (SSD), or in a recording medium such as an IC card, an SD card, and a DVD.

In addition, in each drawing described above, control lines and information lines that are considered necessary for description are shown, and not all the control lines and information lines on implementation are necessarily shown. For example, it may be considered that almost all configurations are actually interconnected.

Arrangements of the various functional units, various processing units, and various databases of the information processing apparatus 10 described above are merely examples. The arrangements of the various functional units, various processing units, and various databases may be changed to optimal arrangements from the viewpoint of performance, processing efficiency, communication efficiency, and the like of hardware and software provided in the information processing apparatus 10.

In addition, the configuration (schema, and the like) of the database storing the above-described various pieces of data may be flexibly changed from the viewpoint of efficient use of resources, improvement in processing efficiency, improvement in access efficiency, improvement in search efficiency, and the like.

In the above embodiment, the upper bound of the penalty coefficient is obtained, and the initial value of the coefficient is set as the upper bound (S1102). In the related art, it is difficult to estimate a sufficient value (upper bound) of the magnitude of the penalty coefficient for a general penalty function, but in the present embodiment, the upper bound can be estimated by narrowing down the target to the logical constraint. When an appropriate coefficient between the upper limit and the lower bound (the lower bound is 0 as schematically shown in FIG. 3) is searched for as necessary, various methods described in PTLs 1 and 2 can be used.

According to the above embodiment, it is possible to provide a technique for obtaining an appropriate approximate value of a penalty coefficient particularly when a constraint condition related to a logical operation between two variables is to be solved using an Ising machine. Since the efficient operation of the Ising machine can be implemented, the energy consumption can be reduced, an amount of carbon emission can be reduced, global warming can be prevented, and a sustainable social can be implemented.

### INDUSTRIAL APPLICABILITY

The invention can be used in an information processing method and an information processing apparatus.

1. An information processing apparatus comprising:
a processor; and
a storage device, wherein
a penalty coefficient setting unit is implemented by the processor and the storage device using a solution finding function for obtaining a solution of a combinatorial optimization problem using a cost function and a constraint condition, and
the penalty coefficient setting unit sets a penalty function and a penalty coefficient based on the constraint condition related to a logical operation imposed between two variables of the cost function and a value of a model coefficient of the cost function such that the solution of the combinatorial optimization problem satisfies the constraint condition, and searches for the solution of the combinatorial optimization problem based on the penalty function and the penalty coefficient.

2. The information processing apparatus according to claim 1, wherein
the penalty coefficient setting unit determines the penalty function for the constraint condition when the constraint condition is a constraint condition for setting at least one logical operation selected from a logical product, a negative logical sum, an imply, and a converse imply imposed between the two variables to true.

3. The information processing apparatus according to claim 2, wherein
the penalty function includes a sign of a correction value to be added to or subtracted from the model coefficient.

4. The information processing apparatus according to claim 1, wherein
the cost function is expressed by a quadratic expression, and
the penalty coefficient setting unit calculates a value of the penalty coefficient based on a value of each coefficient of the quadratic expression.

5. The information processing apparatus according to claim 1, wherein
the penalty coefficient setting unit calculates an upper bound of the penalty coefficient.

6. The information processing apparatus according to claim 1, wherein
the cost function includes an energy function H(x) defined by a plurality of nodes constituting a model based on the combinatorial optimization problem, a nonlinear coefficient acting between the nodes, and a linear coefficient acting on each node,
here, x is a vector having a variable xᵢ corresponding to each node i (i=1 to N, N is a natural number) as an element, each variable xᵢ is a binary variable xᵢ∈{−1, 1} or a continuous variable xᵢ∈[−1, 1], a nonlinear coefficient between the node i and a node j is Jᵢⱼ, a linear coefficient for the node i is hᵢ, and H(x) is the following quadratic expression,
$$H ( x ) := - \frac{1}{2} {x}^{⊤} J x - {h}^{⊤} x ,$$
and
the penalty coefficient setting unit sets the penalty coefficient based on the nonlinear coefficient Jᵢⱼ and the linear coefficient hᵢ which are the model coefficients.

7. The information processing apparatus according to claim 6, wherein
the penalty coefficient setting unit sets an initial value α of the penalty coefficient based on the nonlinear coefficient Jᵢⱼ and the linear coefficient hᵢ which are the model coefficients, and updates the penalty coefficient based on the nonlinear coefficient Jᵢⱼ, the linear coefficient hᵢ, the initial value α of the penalty coefficient, and the penalty function.

8. The information processing apparatus according to claim 1, wherein
the solution finding function obtains a solution of the combinatorial optimization problem using an Ising machine.

9. An information processing method using an information processing apparatus including a processor and a storage device, and an Ising machine that executes a ground state search of an Ising model, the information processing method comprising:
in obtaining a solution of a combinatorial optimization problem that satisfies a constraint condition by the Ising machine searching for a local optimal solution of a function reflecting an energy function and a penalty function,
a first step of the information processing apparatus setting an interaction model using the energy function based on the combinatorial optimization problem;
a second step of the information processing apparatus setting the penalty function based on the constraint condition, and calculating a weight of the penalty function for the solution to satisfy the constraint condition based on the energy function; and
a third step of the Ising machine searching for the solution of the combinatorial optimization problem that satisfies the constraint condition by applying the penalty function and the weight of the penalty function to the energy function.

10. The information processing method according to claim 9, wherein
in the second step, an upper bound of the weight of the penalty function is calculated.
